(19) United States
(12) Patent Application Publication
(10) Pub. No.: US 2003/0204977 A1
(43) Pub. Date: Nov. 6, 2003

(54) Self-illuminating street sign system

(76) Inventor: Richard S. Hong, Los Angeles, CA (US)

Correspondence Address: PARK & SUTTON LLP, 3255 WILSHIRE BLVD, SUITE 1110, LOS ANGELES, CA, 90010, US

(21) Appl. No.: 10/137,629

(22) Filed: May 2, 2002

(51) Int. Cl. G09F 13/00

(52) U.S. Cl. 40/557

(57) ABSTRACT

A self-illuminating street sign system comprises a base panel, reflective surfaces attached on each upper surface of the base panel, translucent boards supported by the base panel to incorporate a description including a street name. An ambient light from above the street sign system is reflected by the reflective surface and directed toward the boards to brighten the description.

### BACKGROUND OF THE INVENTION

The invention relates to a street sign. More particularly, the present invention relates to a self-illuminating street sign system that allows a street name to become brightened without electricity by utilizing ambient light sources such as a street light.

Drivers and pedestrians inevitably rely on street signs to locate a street and an address. It is more than usual for drivers to pass more streets due to poor visibility of street signs, especially, at night. Most street signs in suburban areas are not clear enough at night to read before making a turn. Since street signs are the only guide for drivers, it is understood that an improved brightness of street signs will lead to convenience as well as safety to drivers.

A conventional alternative to poor visibility of street signs has been to use electricity, under which additional maintenance is required, for example, to regularly change bulbs. What makes it further burdensome is external wiring and untidy outlook thereby, as well as electricity that has to come from tax payers.

Accordingly, a demand is to provide a power free street sign that virtually requires no power and no maintenance.

### SUMMARY OF THE INVENTION

The invention is contrived to overcome the conventional disadvantages. Therefore, an object of the invention is to provide a self-illuminating street sign system that allows a street name to become brightened without electricity by utilizing ambient light sources such as a street light.

Another object is to provide clearly readable street signs day and night so that drivers and pedestrians who otherwise might have been disoriented can be conveniently directed on the street.

To achieve the above-described objects, the self-illuminating street sign system comprises a base panel defined by an upper surface, a front edge line, and a rear edge line. A first reflective surface is attached on the upper surface of the base panel, and a first angle by the first reflective surface and the upper surface of the base panel ranges from about 20 degrees to about 70 degrees. A substantially translucent front board has a bottom line, and the bottom line of the front board is fixed to the front edge line of the base panel. A second angle by the base panel and the front board ranges from about 70 degrees to about 135 degrees. The front board has a front description formed along the outer surface thereof so that the front description can be viewed from outside the outer surface of the front board, whereby an ambient light from above the street sign system is reflected by the reflective surface and directed toward the front board to brighten the front description.

The front board is formed by a double layer which includes an inner panel and an outer panel detachably attached to inner panel of the front board, and the outer panel of the front board is incorporated with the front description.

A second reflective surface is attached on the upper surface of the base panel, and a third angle by the second reflective surface and the upper surface of the base panel ranges from about 20 degrees to about 70 degrees. A substantially translucent rear board is defined by inner and outer surfaces, top and bottom lines, wherein the bottom line of the rear board is fixed to the rear edge line of the base panel, and a fourth angle by the base panel and the rear board ranges from about 70 degrees to about 135 degrees. The rear board has a rear description formed along the outer surface thereof so that the rear description can be viewed from outside the outer surface of the rear board, whereby an ambient light from above the street sign system is reflected by the second reflective surface and directed toward the rear board to brighten the rear description.

In an embodiment, the self-illuminating street sign system comprises a housing having an open top, a base panel and a substantially translucent front board, degrees, so an ambient light from above the street sign system passes through the open top, becomes reflected by the reflective surface, and directed toward the front board to brighten the description. A solar pad is partially incorporated on the top panel to collect a light energy. An illuminator provided in the housing and connected to the solar pad to further brighten the description.

The illuminator comprises a power storage to store therein the light energy from the solar pad in form of electricity, and an electroluminescence to illuminate the description, wherein the electroluminescence is connected to and powered by the power storage. The top panel is formed of a light amplifying material. The description may be selected from a street name, a traffic sign, and a mark.

The advantages of the present invention are numerous in that: (1) the self-illuminating street sign system brightens a street name thereon without requiring electric power or generator by adopting a light reflection mechanism in which an ambient light such as street lights is utilized to brighten the street name; (2) although the street sign system provides street sign illumination equivalent to that of an electric powered conventional street sign, it realizes an ideal street sign which is electricity free and maintenance free, thereby maximizing product usability and satisfaction; (3) since the street sign system enables street signs to become brightened day and night and clearly guides drivers or pedestrians to drive or walk under an upgraded safety, street mishaps including traffic accidents can be substantially decreased, thereby satisfying municipalities as well as taxpayers; and (4) an alternate application of solar pad and electroluminescence to the light reflection mechanism enables suburban or rural areas lacking ambient lights to efficiently combine the light reflection and the supplementary solar energy, thereby improving product reliability and applicability.

Although the present invention is briefly summarized, the fuller understanding of the invention can be obtained by the following drawings, detailed description and appended claims.

### BRIEF DESCIPTION OF THE DRAWINGS

These and other features, aspects and advantages of the present invention will become better understood with reference to the accompanying drawings, wherein:

FIG. 1 is a perspective view showing a self-illuminating street sign system according to an embodiment of the present invention;

FIG. 2 is a cross-sectional view of FIG. 1 to show a light reflection mechanism according to the present invention;

FIG. 3 is a cross-sectional view of FIG. 1 to show a construction of the present invention;

FIG. 4 is a perspective view showing the self-illuminating street sign system according to another embodiment of the present invention;

FIG. 5 is a block diagram showing a further embodiment of the present invention; and

FIGS. 6 and 7 are views showing applications of the present invention.

### DETAILED DESCRIPTION OF THE PREFERRED EMBODIMENTS

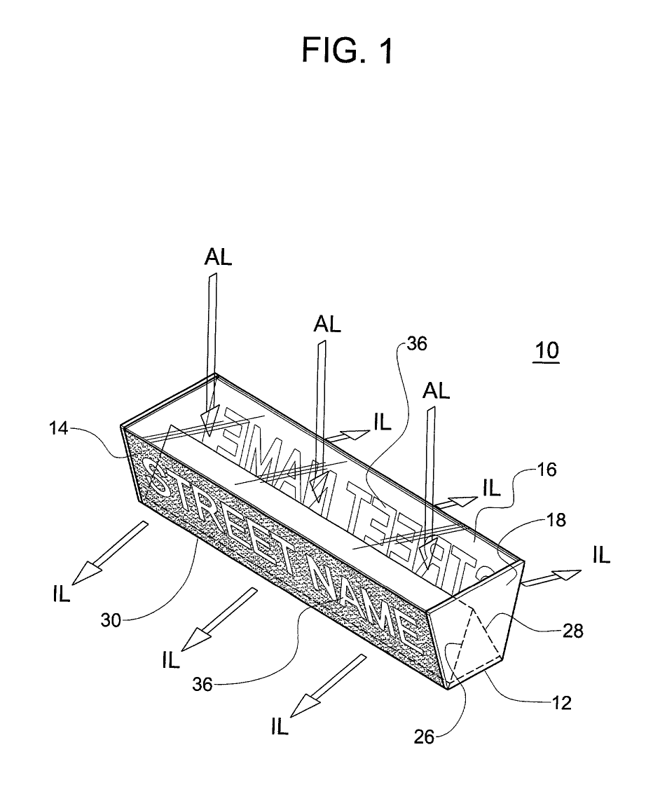

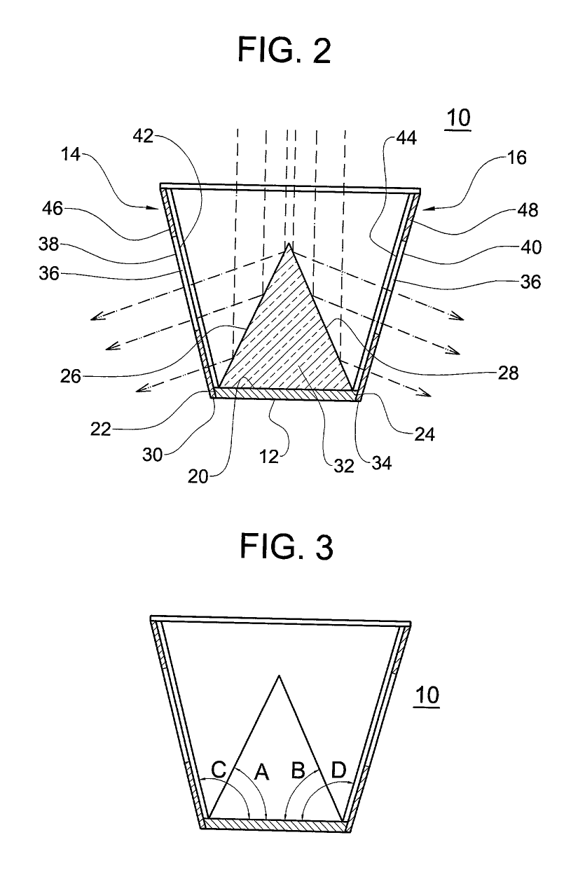

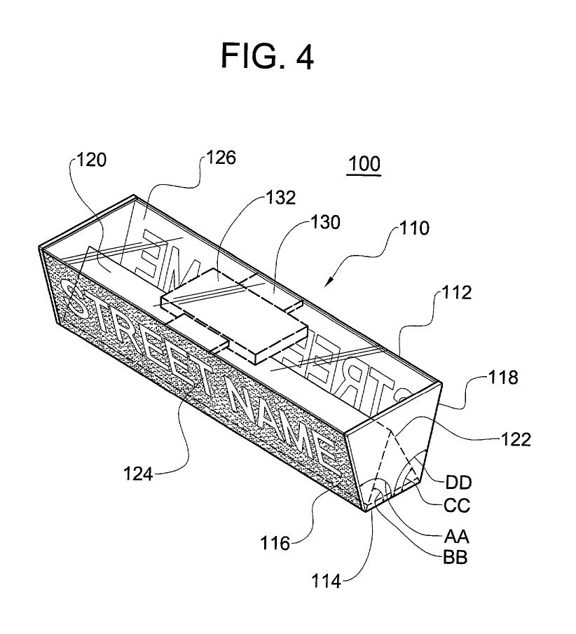

As shown FIGS. 1-3, a self-illuminating street sign system 10 according to the present invention includes a base panel 12, a front board 14, a rear board 16, and side panels 18. The base panel 12 is defined by an upper surface 20, a front edge line 22, and a rear edge line 24. It is preferred that the base panel 12 is formed in a substantially rectangular format but alternate formations may include circular or stepped versions.

A first reflective surface 26 is attached on the upper surface 20 of the base panel 12. Here, a first angle A by the first reflective surface 26 and the upper surface 20 of the base panel 12 ranges from about 20 degrees to about 70 degrees. For a better performance, the first angle A may range from about 30 degrees to about 50 degrees. A second reflective surface 28 may be selectively formed on the upper surface 20 of the base panel 12 in a symmetric format to the first reflective surface 26. Accordingly, a second angle B by the second reflective surface 28 and the upper surface 20 of the base panel 12 ranges from about 20 degrees to about 70 degrees. The second angle B may range from about 30 degrees to about 50 degrees.

The reflective surfaces 26, 28 may be formed of a metallic material that has a substantially high reflectivity. For example, a copper may be employed that shows about 70% reflectivity. The best mode for each reflective surface 26, 28 is to employ a mirror that reserves 100% reflectivity. In order to further improve reflectivity, the reflective surfaces 26, 28 each may be aligned along the base plate 12 in two or more rails to enable an angular variation of the reflective surfaces 26, 28 so as to further maximize reflectivity thereof. Here, the angular variation of the reflective surfaces 26, 28 are implemented relative to the corresponding front and rear boards 14, 16. Selectively, the first and second reflective surfaces 26, 28 may be each upper side of a prismatic stick 32 that reserves a substantial reflectivity along the upper sides serving as first and second reflective surfaces 26, 28.

The front and rear boards 14, 16 are each substantially translucent. Specifically, the bottom line 30 of the front board 14 is fixed to the front edge line 22 of the base panel 12. The rear board 16 is also attached to the base plate 12 in a manner symmetric to the attachment of the front board 14 to the base plate 12. That is, the bottom line 34 of the rear board 16 is fixed to the rear edge line 24 of the rear board 16. Here, a third angle C by the base panel 12 and the front board 14 ranges from about 70 degrees to about 135 degrees. A fourth angle D by the base panel 12 and the rear board 16 ranges from about 70 degrees to about 135 degrees. In a preferred version, the first and second angles A, B each may range between about 30 degrees and about 50 degrees, and the third and fourth angles C, D may easy range between about 90 and about 120 degrees.

The front and rear boards 14, 16 each include a description 36 formed along the outer surfaces 38, 40 thereof so that the description 36 can be viewed from outside the outer surfaces 38, 40 of the front and rear boards 14, 16. Consequently, an ambient light AL from above the street sign system 10 is reflected by the first and second reflective surfaces 26, 28 and directed toward the front and rear boards 14, 16 to brighten the description 36. That is, the ambient light AL is turned to an illuminating light IL by the reflective surfaces 26, 28 and rayed through the description 36 while brightening or illuminating the description 36 or street sign.

The description 36 on each board 14, 16 may be a street name, a traffic sign, or a combination mark including a street name and a mark. The front and rear boards 14, 16 may be each formed by a double layer which includes an inner panel 42, 44 and an outer panel 46, 48 detachably attached to each inner panel 42, 44 of the front and rear boards 14, 16. Each outer panel 46, 48 of the front and rear boards 14, 16 is incorporated with the description 36. Here, the description 36 of the front board 14 is identical to that of the rear board 16.

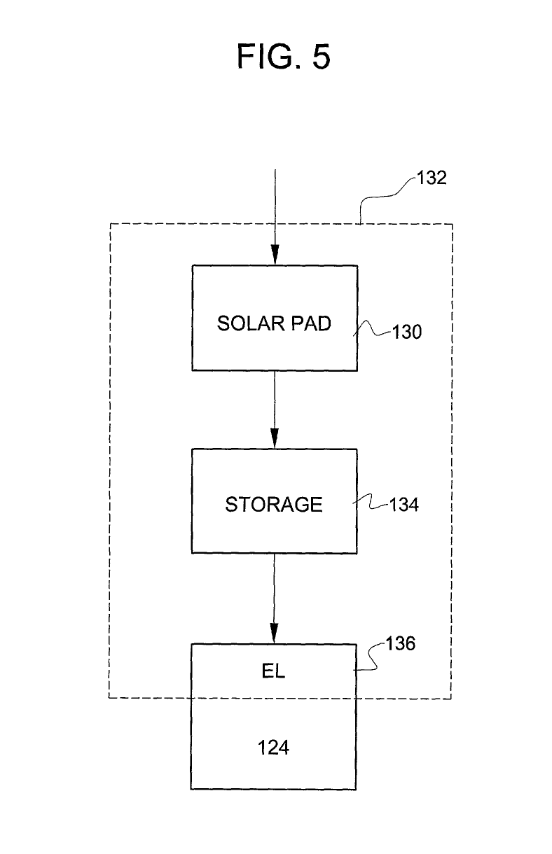

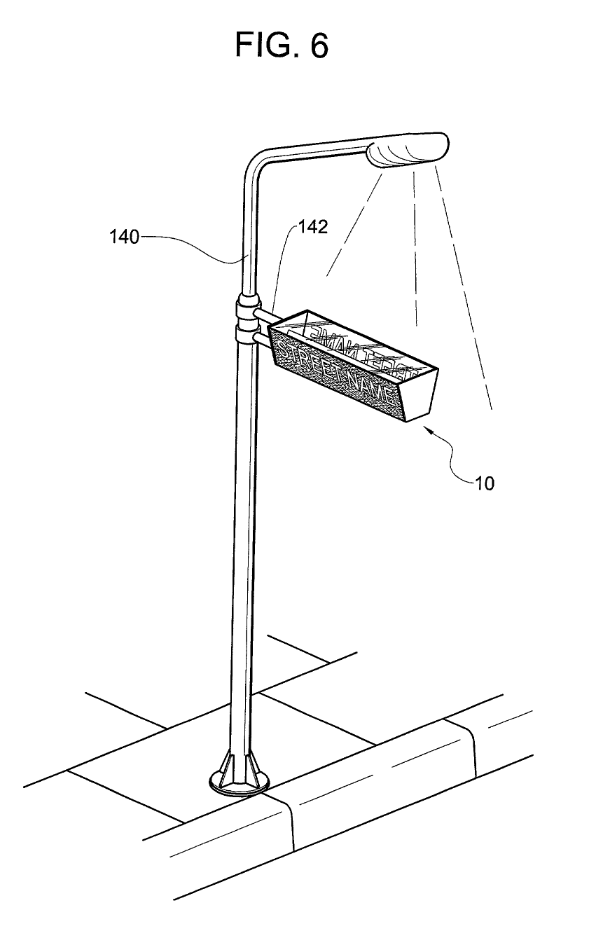

As shown in FIGS. 4 and 5, a self-illuminating street sign system 100 according a preferred embodiment of the present invention comprises a housing 110, first and second reflective surfaces 120, 122. The housing 110 has an open top 112, a base panel 114, substantially translucent front and rear boards 116, 118. A first angle AA by the base panel 114 and the front board 116 ranges from about 70 degrees to about 135 degrees. A second angle BB by the first reflective surface 120 and the base panel 114 ranges from about 20 degrees to about 70 degrees. A third angle CC by the second reflective surface 122 and the base panel 114 ranges from about 20 degrees to about 70 degrees. A fourth angle DD by the base panel 114 and the rear board 118 ranges from about 70 degrees to about 135 degrees. The second and third angles are each between about 30 degrees and about 50 degrees, and the first and fourth angles each is between about 90 and about 120 degrees. The front and rear boards 116, 118 each has a description 124 formed therealong so that the description 124 can be viewed from outside the corresponding boards 116, 118. In this construction, a surrounding light or ambient light from above the street sign system 100 is reflected by the reflective surfaces 120, 122 and directed toward the front and rear boards 116, 118 to brighten the description 124.

The open top 112 of the housing 110 may be covered by a substantially transparent top panel 126. Preferably, the top panel 126 is formed of a light amplifying material to effectively guide the ambient light therethrough to the reflective surfaces 120, 122. The front and rear boards 116, 118 may be each formed by a double layer to facilitate inscription of the description 124.

For a better performance, a solar pad 130 is partially incorporated on the top panel 126 to collect a light energy to alternately brighten the description 124 when required. So the housing 110 further includes an illuminator 132 therein that encompasses the solar pad 130. The illuminator 132 comprises a power storage 134 to store therein the light energy from the solar pad 132 in form of electricity, an electroluminescence 136 to illuminate the description 124. The electroluminescence 134 is connected to and powered by the power storage 134. Selectively, the electroluminescence 136 may be incorporated in form of the description 124

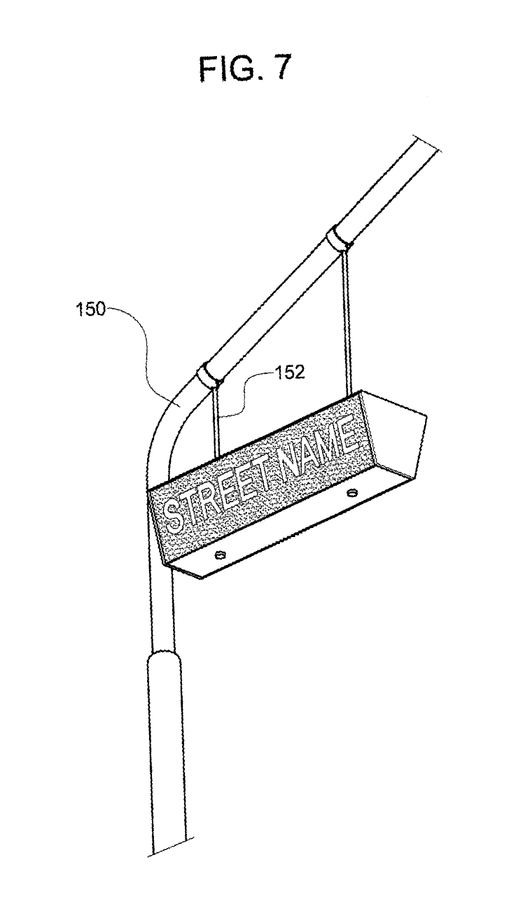

In FIGS. 6 and 7, the self-illuminating street sign system according to the present invention can be installed on a street light post or on a traffic sign post 150 via linkages 142, 152 depending on requirements of residents or municipalities.

An advantage of the present invention is that the self-illuminating street sign system brightens a street name thereon without requiring electric power or generator by adopting a light reflection mechanism in which an ambient light such as street lights is utilized to brighten the street name. In addition, although the street sign system provides street sign illumination equivalent to that of an electric powered conventional street sign, it realizes an ideal street sign which is electricity free and maintenance free, thereby maximizing product usability and satisfaction.

Further, since the street sign system enables street signs to become brightened day and night and clearly guides drivers or pedestrians to drive or walk under an upgraded safety, street mishaps including traffic accidents can be substantially decreased, thereby satisfying municipalities as well as taxpayers. Moreover, an alternate application of solar pad and electroluminescence to the light reflection mechanism enables suburban or rural areas lacking ambient lights to efficiently combine the light reflection and the supplementary solar energy, thereby improving product reliability and applicability.

Although the invention has been described in considerable detail, other versions are possible by converting the aforementioned construction. Therefore, the scope of the invention shall not be limited by the specification specified above and the appended claims.

What is claimed is:

1. A self-illuminating street sign system, comprising:
a) a base panel defined by an upper surface, a front edge line, and a rear edge line;
b) a first reflective surface attached on the upper surface of the base panel, wherein a first angle by the first reflective surface and the upper surface of the base panel ranges from about 20 degrees to about 70 degrees; and
c) a substantially translucent front board defined by inner and outer surfaces, top and bottom lines, wherein the bottom line of the front board is fixed to the front edge line of the base panel, wherein a second angle by the base panel and the front board ranges from about 70 degrees to about 135 degrees, wherein the front board has a front description formed along the outer surface thereof so that the front description can be viewed from outside the outer surface of the front board, whereby an ambient light from above the street sign system is reflected by the first reflective surface and directed toward the front board to brighten the front description.

2. The street sign system of claim 1 wherein the front board is formed by a double layer which includes an inner panel and an outer panel detachably attached to the inner panel of the front board, wherein the outer panel of the front board is incorporated with the front description.

3. The street sign system of claim 1 wherein the first angle is between about 30 degrees and about 50 degrees, and the second angle is between about 90 and about 120 degrees.

4. The street sign system of claim 1 wherein the front description is a street name, a traffic sign, or a mark.

5. The street sign system of claim 1 wherein the first description is a street name and a mark.

6. The street sign system of claim 1 further comprising:
a) a second reflective surface attached on the upper surface of the base panel, wherein a third angle by the second reflective surface and the upper surface of the base panel ranges from about 20 degrees to about 70 degrees; and
b) a substantially translucent rear board defined by inner and outer surfaces, top and bottom lines, wherein the bottom line of the rear board is fixed to the rear edge line of the base panel, wherein a fourth angle by the base panel and the rear board ranges from about 70 degrees to about 135 degrees, wherein the rear board has a rear description formed along the outer surface thereof so that the rear description can be viewed from outside the outer surface of the rear board, whereby an ambient light from above the street sign system is reflected by the second reflective surface and directed toward the rear board to brighten the rear description.

7. The street sign system of claim 6 wherein the rear board is formed by a double layer which includes an inner panel and an outer panel detachably attached to the inner panel of the rear board, wherein the outer panel of the rear board is incorporated with the rear description.

8. The street sign system of claim 6 wherein the third angle is between about 30 degrees and about 50 degrees, and the fourth angle is between about 90 and about 120 degrees.

9. The street sign system of claim 6 wherein the rear description is identical to the front description.

10. A self-illuminating street sign system, comprising:
a) a housing having an open top, a base panel and a substantially translucent front board, wherein a first angle by the base panel and the front board ranges from about 70 degrees to about 135 degrees, wherein the front board has a front description formed along an outer surface thereof so that the front description can be viewed from outside the outer surface of the front board; and
b) a first reflective surface provided in and attached to the housing, wherein a second angle by the reflective surface and the base panel ranges from about 20 degrees to about 70 degrees, whereby an ambient light from above the street sign system passes through the open top, becomes reflected by the reflective surface, and directed toward the front board to brighten the front description.

11. The street sign system of claim 10 wherein the front board is formed by a double layer which includes an inner panel and an outer panel detachably attached to the inner panel of the front board, wherein the outer panel of the front board is incorporated with the front description.

12. The street sign system of claim 10 wherein the first angle is between about 90 degrees and about 120 degrees, and the second angle is between about 30 and about 50 degrees.

13. The street sign system of claim 10 wherein the front description is a street name, a traffic sign, or a mark.

14. The street sign system of claim 10 wherein the first description is a street name and a mark.

15. The street sign system of claim 10 further comprising:
a) a second reflective surface attached on the upper surface of the base panel, wherein a third angle by the second reflective surface and the upper surface of the base panel ranges from about 20 degrees to about 70 degrees; and
b) a substantially translucent rear board having a bottom line, wherein the bottom line of the rear board is fixed to the rear edge line of the base panel, wherein a fourth angle by the base panel and the rear board ranges from about 70 degrees to about 135 degrees, wherein the rear board has a rear description formed along an outer surface thereof so that the rear description can be viewed from outside the outer surface of the rear board, whereby an ambient light from above the street sign system is further reflected by the second reflective surface and directed toward the rear board to brighten the rear description.

16. The street sign system of claim 15 further comprising a substantially transparent top panel to cover the open top of the housing.

17. The street sign system of claim 16 wherein the top panel is formed of a light amplifying material.

18. The street sign system of claim 15 wherein the rear board is formed by a double layer which includes an inner panel and an outer panel detachably attached to the inner panel of the rear board, wherein the outer panel of the rear board is incorporated with the rear description.

19. The street sign system of claim 15 wherein the third angle is between about 30 degrees and about 50 degrees, and the fourth angle is between about 90 and about 120 degrees.

20. The street sign system of claim 15 wherein the rear description is identical to the front description.

21. A self-illuminating street sign system, comprising:
a) a housing having an open top, a base panel and a substantially translucent front board, wherein a first angle by the base panel and the front board ranges from about 70 degrees to about 135 degrees, wherein the front board has a front description formed along an outer surface thereof so that the front description can be viewed from outside the outer surface of the front board;
b) a first reflective surface provided in and attached to the housing, wherein a second angle by the reflective surface and the base panel ranges from about 20 degrees to about 70 degrees, whereby an ambient light from above the street sign system passes through the open top, becomes reflected by the first reflective surface, and directed toward the front board to brighten the front description;
c) a substantially transparent top panel to cover the open top of the housing, wherein a solar pad is partially incorporated on the top panel to collect a light energy; and
d) an illuminator provided in the housing and connected to the solar pad to further brighten the front description.

22. The street sign system of claim 21 wherein the illuminator comprises:
a) a power storage to store therein the light energy from the solar pad in form of electricity; and
b) an electroluminescence to illuminate the description, wherein the electroluminescence is connected to and powered by the power storage.

23. The street sign system of claim 21 wherein the top panel is formed of a light amplifying material.

24. The street sign system of claim 21 wherein the front board is formed by a double layer which includes an inner panel and an outer panel detachably attached to the inner panel of the front board, wherein the outer panel of the front board is incorporated with the front description.

25. The street sign system of claim 21 wherein the first angle is between about 90 degrees and about 120 degrees, and the second angle is between about 30 and about 50 degrees.

26. The street sign system of claim 21 wherein the front description is a street name, a traffic sign, or a mark.

27. The street sign system of claim 21 wherein the first description is a street name and a mark.

28. The street sign system of claim 21 further comprising:
a) a second reflective surface attached on the upper surface of the base panel, wherein a third angle by the second reflective surface and the upper surface of the base panel ranges from about 20 degrees to about 70 degrees; and
b) a substantially translucent rear board having a bottom line, wherein the bottom line of the rear board is fixed to the rear edge line of the base panel, wherein a fourth angle by the base panel and the rear board ranges from about 70 degrees to about 135 degrees, wherein the rear board has a rear description formed along an outer surface thereof so that the rear description can be viewed from outside the outer surface of the rear board, whereby an ambient light from above the street sign system is reflected by the second reflective surface and directed toward the rear board to brighten the rear description.

29. The street sign system of claim 28 wherein the rear board is formed by a double layer which includes an inner panel and an outer panel detachably attached to inner panel of the rear board, wherein the outer panel of the rear board is incorporated with the rear description.

30. The street sign system of claim 21 wherein the third angle is between about 30 degrees and about 50 degrees, and the fourth angle is between about 90 and about 120 degrees.

31. The street sign system of claim 21 wherein the rear description is identical to the front description.
